(19) United States
(12) Patent Application Publication
(10) Pub. No.: US 2010/0329621 A1
(43) Pub. Date: Dec. 30, 2010

(54) Fiber Optic Cable Slack Storage Module

(76) Inventors: Elli Makrides-Saravanos, Highland Village, TX (US); Kevin L. Strause, Keller, TX (US)

Correspondence Address: CORNING INCORPORATED, INTELLECTUAL PROPERTY DEPARTMENT, SP-TI-3-1, CORNING, NY, 14831, US

(21) Appl. No.: 12/492,174

(22) Filed: Jun. 26, 2009

(51) Int. Cl. G02B 6/00

(52) U.S. Cl. 385/135

(57) ABSTRACT

A fiber optic cable slack storage module is disclosed. The fiber optic cable slack storage module has a base with an interior space. A plate having a plate top and a plate bottom mounts in the interior space. The plate is adapted to receive and support an upper fiber optic cable at the plate top and a lower fiber optic cable at the plate bottom. The upper fiber optic cable arranges in the interior space in a serpentine configuration at the plate top. The lower fiber optic cable arranges in the interior space in a serpentine configuration at the plate bottom. The serpentine configuration allows the upper and lower fiber optic cables to enter and exit the fiber optic cable slack storage module in a way to avoid the probability of severe bending.

### BACKGROUND

1. Field of the Disclosure

The technology of the disclosure relates to a fiber optic apparatus, and more particularly to a module for storing fiber optic cable slack.

2. Technical Background

Benefits of optical fiber use include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include interconnections having connection points at which it is necessary to link optical fibers in order to transmit optical signals carried by the optical fibers. In this regard, fiber optic equipment is located in data centers or central offices to support such interconnections.

The fiber optic equipment is typically located and mounted in equipment racks. Fiber optic cables, particularly fiber optic cables containing multiple optical fibers, route to and between the equipment racks to allow for such interconnections to the equipment mounted in the particular equipment rack and to other fiber optic cables. The fiber optic cables have connectors on each end which mate with other connectors to establish the interconnection. The mating of the connectors may be accomplished through a suitable adapter which provides for secure, stable physical mating of the connectors and the continued integrity of the optical signal carried by the fiber optic cable at the connection point. To facilitate and enhance the ease in which interconnections may be made, the fiber optic cable typically may be shipped to the data center or central office preconnectorized at the factory. This allows for a plug-and-play type of installation.

To simplify the manufacturing process, the fiber optic cables may be fabricated in one or more standardized lengths. As such, a standard length of fiber optic cable having preconnectorized ends may be used to interconnect equipment in a data center or central office. The length of fiber optical cable needed for each such interconnection of equipment depends upon the location of the equipment on the equipment rack and the location of the equipment rack, if the fiber optic cable routes between different equipment racks. These locations may vary considerably in distance in the data center or the central office.

While the use of a standard length of preconnectorized fiber optic cable may facilitate its fabrication and installation, a length of fiber optic cable slack may result. Such slack may be longer or shorter depending on the difference between the standard length and the actual distance between connection points. However, each fiber optic cable in the data center or central office may have some length, however short, of slack. This may result in an unmanageable situation due to the excess fiber optic cable lengths that have no place to be stored except possibly in vertical and horizontal raceways. This may cause an unsightly visual entanglement and logistical chaos in tracing tangled fiber optic cables. Additionally, the length of slack may change if an interconnection is changed, added, and/or eliminated. This may occur if fiber optic equipment and/or equipment racks are moved, added, and/or changed, which directly affects the location and/or existence of connection points. Therefore, a need exists for effectively and dynamically managing the slack of the fiber optic cables in the data center or central office.

### SUMMARY

In one aspect there is provided a fiber optic cable slack storage module having a base that defines an interior space. The interior space is adapted to receive and support a first fiber optic cable in a serpentine configuration, and to allow movement of the first fiber optic cable into and out of the slack storage module. A portion of the first fiber optic cable extends externally of the fiber optic slack storage module. A pulling force applied to the portion of the first fiber optic cable extending externally to the fiber optic slack storage module causes the serpentine configuration of the first fiber optic cable to begin to straighten and a portion of the first fiber optic cable to exit the slack storage module. A pushing force applied to the portion of the first fiber optic cable extending externally to the fiber optic slack storage module causes a portion of the first fiber optic cable to enter the slack storage module and to arrange in the slack storage module in a serpentine configuration. The serpentine configuration may comprise a plurality of loops of the first fiber optic cable in a back and forth arrangement. The serpentine configuration may comprise a plurality of loops of the first fiber optic cable in a side-by-side arrangement. The plurality of loops of the first fiber optic cable may be arranged so as not to overlap or at least two of the loops may overlap.

The loops may be arranged across at least a portion of the width of the slack storage module. Additionally or alternatively, the loops may be arranged across at least a portion of the length of the slack storage module. The serpentine configuration of the first fiber optic cable may be arranged generally horizontally in the slack storage module. The serpentine configuration of the first fiber optic cable may be arranged generally vertically, or at some angle to the horizontal plane, in the slack storage module.

The interior space may also be adapted to receive and support a second fiber optic cable arranged in a serpentine configuration. The interior space may be adapted to store at least about 54 inches each of the first fiber optic cable and the second fiber optic cable. The interior space may also be adapted to store from about 50 inches to about 60 inches of the first fiber optic cable. The interior space may also be adapted to store from about 40 inches to about 70 inches of the first fiber optic cable. The fiber optic slack storage module removably installs in a fiber optic equipment tray without the need for any modification or adaptation of the fiber optic equipment tray.

In another aspect, there is provided a fiber optic cable slack storage module having a base comprising a first end, a second end, a first side and a second side defining an interior space, and wherein the base has a base top and a base bottom. A plate having a plate top and a plate bottom mounts in the interior space. The plate top orients substantially in the direction of the base top and plate bottom orients substantially in the direction of the base bottom. The plate is adapted to receive and support an upper fiber optic cable at the plate top in a first serpentine configuration and a lower fiber optic cable at the plate bottom in a second serpentine configuration. A portion of the upper fiber optic cable extends externally of the fiber optic slack storage module, and a portion of the lower fiber optic cable extends externally of the fiber slack storage module. The first serpentine configuration may be substantially the same as the second serpentine configuration. One of the first serpentine configuration and the second serpentine configuration may comprise a plurality of loops in a back and forth arrangement.

The fiber optic cable slack module may also include an upper adapter slot located in the first end and an upper connector cut-out in the plate and extending from the upper adapter slot. The upper adapter slot may be configured to receive an upper adapter for receiving an upper connector attached to a first end of the upper fiber optic cable. The upper connector cut-out provides access to the upper adapter, the upper connector and the upper fiber optic cable at the upper connector. A first boot slot in the second end is configured to receive a first boot. The upper fiber optic cable exits and enters the cable slack storage module through the first boot.

A pulling force applied to the portion of the upper fiber optic cable extending externally to the fiber optic slack storage module causes first serpentine configuration of the upper fiber optic cable to begin to straighten and a portion of the upper fiber optic cable to exit the slack storage module through the first boot. A pushing force applied to the portion of the upper fiber optic cable extending externally to the fiber optic slack storage module causes a portion of the upper fiber optic cable to enter the slack storage module through the first boot and to arrange in the slack storage module in the first serpentine configuration.

The fiber optic cable slack module may also include a lower adapter slot located in the first end and a lower connector cut-out in the plate and extending from the lower adapter slot. The lower adapter slot may be configured to receive a lower adapter for receiving a lower connector attached to a first end of the lower fiber optic cable. The lower connector cut-out provides access to the lower adapter, the lower connector and the lower fiber optic cable at the lower connector. A second boot slot in the second end is configured to receive a second boot. The lower fiber optic cable exits and enters the cable slack storage module through the second boot.

A pulling force applied to the portion of the lower fiber optic cable extending externally to the fiber optic slack storage module causes the second serpentine configuration of the lower fiber optic cable to begin to straighten and a portion of the lower fiber optic cable to exit the slack storage module through the second boot. A pushing force applied to the portion of the lower fiber optic cable extending externally to the fiber optic slack storage module causes a portion of the lower fiber optic cable to enter the slack storage module through the second boot and to arrange in the slack storage module in the second serpentine configuration.

The first end has an extended portion formed therein. The extended portion extends the length of the fiber optic cable slack storage module. An upper cover removably attaches to the base top by sliding between at least one upper tab attached to the base top and the base top. A lower cover removably attaches to the base bottom by sliding between at least one lower tab attached to the base bottom and the base bottom.

A first side rail attaches to the first side and a second side rail attaches to the second side. A latch positions in the second side rail. The first side rail and the second side rail insert into grooves in module rail guides in a fiber optic equipment tray to easily install and removably attach the fiber optic cable slack storage module in the fiber optic equipment tray. The latch inserts into a detent in one of the module rail guides to releasably lock the fiber optic cable slack storage module in the fiber optic equipment tray. A thumb pull and a finger pull may be attached to the second end. The thumb pull and the finger pull may be used to remove the fiber optic cable slack storage module from the fiber optic equipment tray. The fiber optic slack storage module removably installs in a fiber optic equipment tray without the need for any modification or adaptation of the fiber optic equipment tray.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the embodiments. The accompanying drawings are included to provide a further understanding of the embodiments, and are incorporated into and constitute a part of this specification. The drawings illustrate various embodiments and together with the description serve to explain the principles and operation of the embodiments.

### BRIEF DESCRIPTION OF THE FIGURES

FIG. 1 is a plan view of a top of a slack storage module with the top removed showing an upper fiber optic cable and a lower fiber optic cable stored therein arranged in a serpentine configuration in line with the transverse axis of the slack storage module, with connectors, adapters and boots, according to an embodiment;

FIG. 2 is an exploded, perspective view of the slack storage module of FIG. 1 without the fiber optic cable, connectors, adapters, and boots;

FIG. 3 is a section view of the slack storage module of FIG. 2 cut transversely through the slack storage module;

FIG. 4A is a plan view of a slack storage module with the fiber optic cable arranged in a serpentine configuration in line with the longitudinal axis of the slack storage module, according to an embodiment;

FIG. 4B is an elevation view of a slack storage module with the fiber optic cable arranged in a serpentine configuration in a generally vertical plane, according to an embodiment;

FIG. 5 is a top, right perspective view of the slack storage module of FIG. 1 in assembled form; and

FIG. 6 is a plan view of the slack storage module of FIG. 1 installed in a fiber optic equipment tray along with a connection module.

### DETAILED DESCRIPTION

Reference will now be made in detail to the embodiments, examples of which are illustrated in the accompanying drawings, in which some, but not all embodiments are shown. Indeed, the embodiments may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

It should be understood that the term “slack storage module,” “fiber optic slack storage module,” and “fiber optic cable slack storage module” may be used interchangeably. Further, fiber optic cables may be trunk cables routed between the equipment and the components located in different equipment racks, or jumper cables routed between the equipment or components within the same equipment rack. Further, as used herein, it is intended that terms “fiber optic cable,” “fiber optic cables,” “optical fiber,” and/or “optical fibers” include all types of single mode and multi-mode light waveguide or waveguides, including one or more bare optical fibers, loose-tube optical fibers, tight-buffered optical fibers, ribbonized optical fibers, bend-insensitive optical fibers, or any other expedient of a medium for transmitting light signals.

References herein to “top,” “upward,” “upper,” “higher,” “lower,” “bottom,” “downward,” “side,” “first,” and “second” structures, elements, designations, geometries and the like are intended solely for purposes of providing an enabling disclosure and in no way suggest limitations regarding the operative orientation or order of the exemplary embodiments or any components thereof.

Embodiments disclosed in the detailed description include a fiber optic cable slack storage module. The fiber optic cable slack storage module has a structure comprising a base with an interior space. The interior space is adapted to receive and support one or more fiber optic cables. The fiber optic cables may be arranged in the interior space in a serpentine configuration. The serpentine configuration may include one or more bends or loops of the fiber optic cable. Moreover, the loops may be arranged in side-to-side, back and forth and/or reversing pattern. The loops may be arranged so that none of the loops overlap, or so that one or more loops overlap. However, in the case of more than one fiber optic cable, it is not necessary that one fiber optic cable have a similar serpentine configuration as another fiber optic cable.

The serpentine configuration may be oriented such that the loops arrange across the width or in line with the transverse axis of the fiber optic cable slack storage module as the fiber optic cable extends along the length or in line with the longitudinal axis of the fiber optic cable slack storage module. Additionally, the serpentine configuration may be generally flat being in a generally horizontal plane. Other orientations are also possible. As a non-limiting example, the serpentine configuration although in a horizontal plane may be along the length or in line with the longitudinal axis of the fiber optic cable slack storage module as the fiber optic cable extends along the length or in line with the longitudinal axis, of the fiber optic cable slack storage module. As another non-limiting example, the serpentine configuration may be oriented at a generally vertical plane or at any angle to the horizontal plane. Other configurations are possible.

In an exemplary embodiment a plate having a plate top and a plate bottom may mount in the interior space. The interior space may be adapted to receive and support the one or more fiber optic cables using the plate. Thus, the plate may be adapted to receive and support the one or more fiber optic cables. One of the one or more fiber optic cables may be an upper fiber optic cable and be received and supported by the plate top. Similarly, one or more of the fiber optic cables may be a lower fiber optic cable and be received and supported at the plate bottom. In this manner, the upper fiber optic cable arranges in the interior space in the serpentine configuration at the plate top. And the lower fiber optic cable arranges in the interior space in the serpentine configuration at the plate bottom. The serpentine configuration of the fiber optic cable may allow the fiber optic cable to enter and exit the fiber optic cable slack storage module in a way that avoids the probability of severe bending of the fiber optic cable.

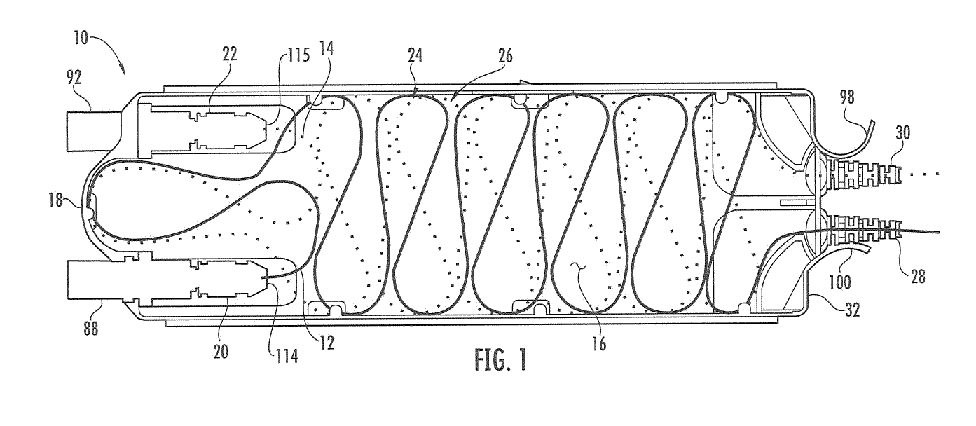

Exemplary embodiments of the structure of the fiber optic cable slack storage module and the different fiber optic cable orientations are shown in and discussed with respect to the figures beginning with FIG. 1. The exemplary embodiments so shown and discussed should not be considered as in any way limiting the manner in which the fiber optic cable slack storage module may be structured, or the manner in which the fiber optic cable may be oriented in the fiber optic cable slack storage structure, or may enter and/or exit the fiber optic slack storage module.

Referring now to FIG. 1, there is shown an embodiment of a slack storage module 10. The slack storage module 10 is adapted to receive and store slack of an upper fiber optic cable 12 and a lower fiber optic cable 14. The lower fiber optic cable 14 is shown in dashed lines as it is hidden in FIG. 1 by plate 16 mounted in the slack storage module 10. The upper fiber optic cable 12 and the lower fiber optic cable 14 each terminates at a first end 18 in an upper connector 20 and a lower connector 22, respectively. The upper fiber optic cable 12 connects to the upper connector 20 at first end 114. The lower fiber optic cable 14 connects to the lower connector 22 at first end 115. The upper fiber optic cable 12 and the lower fiber optic cable 14 extend in the slack storage module 10 in a serpentine configuration 24, 26, respectively. Although, in FIG. 1, the serpentine configuration is depicted in a flat, non-overlapping, continuous arrangement, any serpentine configuration may be used. For example, some or all of the loops may overlap.

The plate 16 separates and supports the upper fiber optic cable 12, and the lower fiber optic cable 14, as the upper fiber optic cable 12 and the lower fiber optic cable 14 extend in the slack storage module 10. In this embodiment, the slack storage module 10 may be configured to store at least about 54 inches each of the upper fiber optic cable 12 and the lower fiber optic cable 14. In this way, about 46 inches each of the upper fiber optic cable 12 and the lower fiber optic cable 14 may be extended out of the slack storage module 10. However, any length of the upper fiber optic cable 12 and the lower fiber optic cable 14 may be stored in the slack storage module 10. For example, in another embodiment, the slack storage module 10 may be configured to store about 50 inches to about 60 inches each of the upper fiber optic cable 12 and the lower fiber optic cable 14. In such example, about 42 inches to about 52 inches each of the upper fiber optic cable 12 and the lower fiber optic cable 14 may be extended out of the slack storage module 10. As another example, in another embodiment the slack storage module 10 may be configured to store about 40 inches to about 70 inches each of the upper fiber optic cable 12 and the lower fiber optic cable 14. In such example, about 32 inches to about 62 inches each of the upper fiber optic cable 12 and the lower fiber optic cable 14 may be extended out of the slack storage module 10. Additionally, the upper fiber optic cable 12 and the lower fiber optic cable 14 each may be fabricated as a preconnectorized harness with the upper connector 20, the lower connector 22 and boots 28, 30 pre-installed on the upper fiber optic cable 12 and the lower fiber optic cable 14, respectively. The boots 28, 30 are configured to allow the upper fiber optic cable 12 and the lower fiber optic cable 14, respectively, to movably pass into and out of the slack storage module 10. Thus, varying lengths of the upper fiber optic cable 12 may enter and/or exit the slack storage module 10 through boot 28. And varying lengths of the lower fiber optic cable 14 may exit and enter the slack storage module 10 through boot 30. In other words, the upper fiber optic cable 12 and/or the lower fiber optic cable 14 may extend from and retract into the slack storage module 10, through the boots 28, 30.

While the following discussion refers to the upper fiber optic cable 12, it should be understood that the discussion similarly applies to the lower fiber optic cable 14. A length of the upper fiber optic cable 12 may be caused to exit the slack storage module 10 through boot 28 by applying a pulling force to a portion of the upper fiber optic cable 12 extending outside of the slack storage module 10. A length of the upper fiber optic cable 12 may be caused to enter the slack storage module 10 through boot 28 by applying a pushing force to a portion of the upper fiber optic cable 12 extending outside of the slack storage module 10. Applying the pulling force to the portion of the upper fiber optic cable 12, causes the upper fiber optic cable 12 to begin to straighten out of the serpentine configuration 24 as a portion of the upper fiber optic cable 12 moves out of the slack storage module 10 through the boot 28. Applying the pushing force to the portion of the upper fiber optic cable 12, causes the upper fiber optic cable 12 to begin to arrange back into the serpentine configuration in the slack storage module 10 as a portion of the upper fiber optic cable 12 moves into the slack storage module 10 through the boot 28.

In this manner, the bend diameter of the loop of and/or bend in the upper fiber optic cable 12 enlarges as the pulling force is applied and the upper fiber optic cable 12 begins to partially straighten out of the serpentine configuration and moves out of the slack storage module 10. Additionally, the bend diameter of the loop of and/or bend in the upper fiber optic cable 12 remains above a minimum required bend diameter as the pushing force is applied and the upper fiber optic cable 12 arranges back into the serpentine configuration in the slack storage module 10. Because of this, the upper fiber optic cable 12 does not experience severe bending, which may cause high insertion loss or even fiber breakage. For example, by way of illustration only and not to be interpreted as in any way limiting, insertion loss may be limited to about 0.1 dB @850 nm for bend insensitive fibers, or to about 0.1 dB @1310 nm for non-bend insensitive fibers. Additionally, the pulling force and/or the pushing force may be applied to the upper fiber optic cable 12 using any manual or mechanical biasing or forcing means.

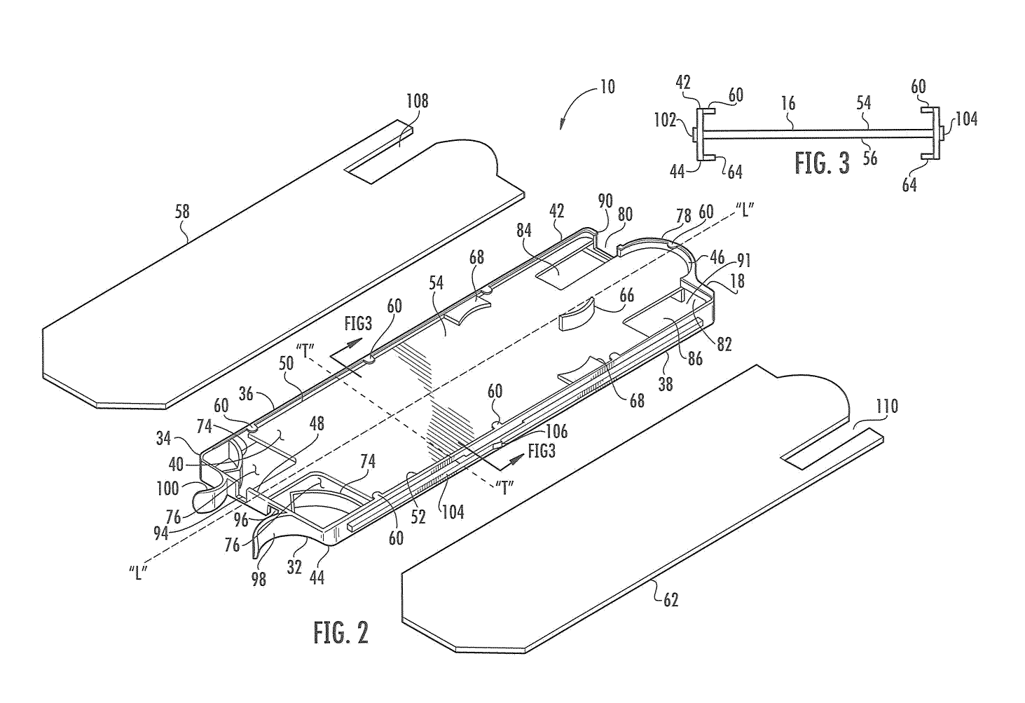

Referring now to FIG. 2, detail of the structure of the slack storage module 10 is further illustrated. To facilitate the discussion of the structure of the slack storage module 10, the upper fiber optic cable 12, the lower fiber optic cable 14, the fiber optic connectors 20, 22, and the boots 28, 30 are omitted in FIG. 2. However, in discussing FIG. 2 reference will also be made to FIG. 1 when necessary to adequately describe the aspects or portions of the slack storage module 10 structure.

The slack storage module 10 has a generally rectangular shaped base 34 formed by the first end 18, the second end 32, a first side 36, and a second side 38. The first side 36 and the second side 38 extend between and connect to respective opposing ends of the first end 18 and the second end 32 to define an interior space 40. In this way, the first side 36 and second side 38 may align substantially parallel to a longitudinal axis “L” of the base 34, and, therefore, of the interior space 40. And the first end 18 and the second end 32 may align substantially parallel to a transverse axis “T” of the base 34, and, therefore, of the interior space 40.

The base 34 has a base top 42 and a base bottom 44. In the embodiment shown in FIG. 2, the base top 42 is shown having an open area framed by the first end 18, the second end 32, the first side 36, and the second side 38. Although, not shown in FIG. 2, the base bottom 44 may also have a similar open area. The open areas provide for access to the interior space 40. Other embodiments may provide for one or both of the base top 42 and base bottom 44 to be closed and, therefore, not have an open area. For example, an embodiment may provide for the base top 42 to have an open area while the base bottom 44 does not have an open area, or vice-versa. Additionally, neither the base top 42 nor the base bottom 44 may have an open area and access to the interior space 40 may be provided by some other means. For example, without limitation, the first end 18, the second end 32, the first side 36 and/or the second side 38 may be hinged to allow the slack storage module 10 to swing open along the hinge to gain access to the interior space 40. The plate 16 is positioned in the interior space 40 between the base top 42 and the base bottom 44 and connects to the base 34 on plate edges 46, 48, 50, 52 to the first end 18, the second end 32, the first side 36 and the second side 38, respectively. The plate top 54 is oriented substantially toward the base top 42 and the plate bottom 56 is oriented substantially toward the base bottom 44.

An upper cover 58 removably attaches to the base 34 at the base top 42 by sliding between upper tabs 60 and the base top 42. A lower cover 62 removably attaches to the base 34 at the base bottom 44 by sliding between lower tabs 64 and base bottom 44 (shown on FIG. 3). As discussed above, other embodiments may provide for one or both of the base top 42 and base bottom 44 to be closed, in such case an upper cover 58 or a lower cover 62 may not be included. Although in this embodiment upper tabs 60 and lower tabs 64 are used to removably attach the upper cover 58 and lower cover 62, respectively, to the base 34, any means, structure, or mechanism may be used. Additionally or alternatively, the upper tabs 60 and/or lower tabs 64 may be used to retain the upper fiber optic cable 12 and lower fiber optic cable 14, respectively, in the serpentine configuration. The upper tab 60 and/or lower tabs 64 may perform this function until the upper cover 58 and lower cover 62 are attached to the base 34 or independently of the upper cover 58 and lower cover 62.

An upper center cable guide 66 and upper side cable guides 68 are shown in FIG. 2 attach to the plate top 54. Although not shown in FIG. 2, lower center cable guide 70 and lower side cable guides 72 attach to the plate bottom 56 in a similar fashion. End guides 74 attach to the second end 32 and extend through the plate 16 from the base top 42 to the base bottom 44 through cut-outs 76, which extend through the plate 16 from the plate top 54 to the plate bottom 56. The first end 18 has an extended portion 78 located medially thereat that extends the base 34 outwardly substantially in the longitudinal axis “L” direction. The upper center cable guide 66, the upper side guides 68, the end guides 74, and the extended portion 78 are configured to provide for the serpentine configuration of the upper fiber optic cable 12 as discussed above with regard to FIG. 1. In a similar manner, lower center cable guide 70, lower side cable guides 72, end guides 74 and the extended portion 78 are configured to provide for the serpentine configuration of the lower fiber optic cable 14. Other embodiments are possible which do not include the upper center cable guide 66, the upper side cable guides 68, the lower center cable guide 70 and the lower side cable guides 72. Such other embodiments may include a cable guide formed in or as part of the plate top 54 and/or plate bottom 56. Other types of cable guides or fixtures may be used to install the upper fiber optic cable 12 and lower fiber optic cable 14 in the slack storage module 10.

Upper adapter slot 80 and lower adapter slot 82 are formed at the first end 18 and extend to upper connector cut-out 84 and lower connector cut-out 86. An upper adapter 88 removably attaches to the base 10 by inserting the upper adapter 88 into the upper adapter slot 80 through upper adapter access slit 90 from the base top 42. A lower adapter 92 removably attaches to the base 10 by inserting the lower adapter 92 into the lower adapter slot 82 through lower adapter access slit 91 from the base bottom 44. The upper connector cut-out 84 and lower connector cut-out 86 provide for finger access for installing the upper adapter 88 and the lower adapter 92 in the base 10. Additionally, the upper connector cut-out 84 and lower connector cut-out 86 provide for finger access, generally, to the upper adapter 88, the lower adapter 92, the upper connector 20, and the lower connector 22. Upper cover cut-out 108 positions over upper connector cut-out 84 when the upper cover 58 is removably attached to the base 10. Lower cover cut-out 110 positions over lower connector cut-out 86 when the lower cover 62 is removably attached to the base 10. In this manner, the upper connector 20 and upper adapter 88 may be accessed when the upper cover 58 is removably attached to the base 10. Similarly, the lower connector 22 and lower adapter 92 may be accessed when the upper cover 62 is removably attached to the base 10. The upper adapter 88 and lower adapter 92 may be any type of fiber optic adapter. In this embodiment, the upper adapter 88 and lower adapter 92 are multi-fiber MTP fiber optic adapters equipped to establish connections to multiple optical fibers (e.g., twelve (12) optical fibers). Thus, in this embodiment, the upper connector 20 and the lower connector 22 are multi-fiber connectors.

Upper boot slot 94 and lower boot slot 96 are formed in the second end 32 so as to be located medially thereat. The upper boot slot 94 opens at the base top 42 while the lower boot slot 96 opens at the base bottom 44. The boots 28, 30 removably attach to the base 10 by inserting into the upper or lower boot slots 94, 96, respectively. Thumb pull 98 extends outwardly from the second end 32 at a location between the lower boot slot 96 and the second side 38. Finger pull 100 extends outwardly from the second end 32 at a location between the upper boot slot 94 and the first side 36. First side rail 102 is attached to the first side 36, while second side rail 104 is attached to second side 38. Second side rail 104 includes latch 106 located approximately one half the distance along the second side rail 104. The function and operation of the first side rail 102, second side rail 104, latch 106, thumb pull 98 and finger pull 100 will be discussed more fully below. A section cut through the base 34 on FIG. 2 is shown in FIG. 3. As can be seen from FIG. 3, the base 34 is in an “H” formed by first side 36 and second side 38 with the plate 16 extending therebetween. The plate 16 attaches to the first side 36 and second side 38 at substantially their respective midpoints. In this way, the base top 42 and the base bottom 44 may be substantially identical.

The base 34 may be any size, but in the embodiment shown in FIG. 2, base 34 may be about 10.2 inches long, not including the extended portion 78, the thumb pull 98 and the finger pull 100. The overall length of the slack storage module 10 including the extended portion 78, the thumb pull 98 and finger pull 100 may be about 12 inches. The width of the slack storage module 10 may be about 3.5 inches. The structure of the slack storage module 10 allows it to be installed in a fiber optic cable tray without adjusting or modifying the fiber optic cable tray specifically for the slack storage module 10. This is discussed in more detail below.

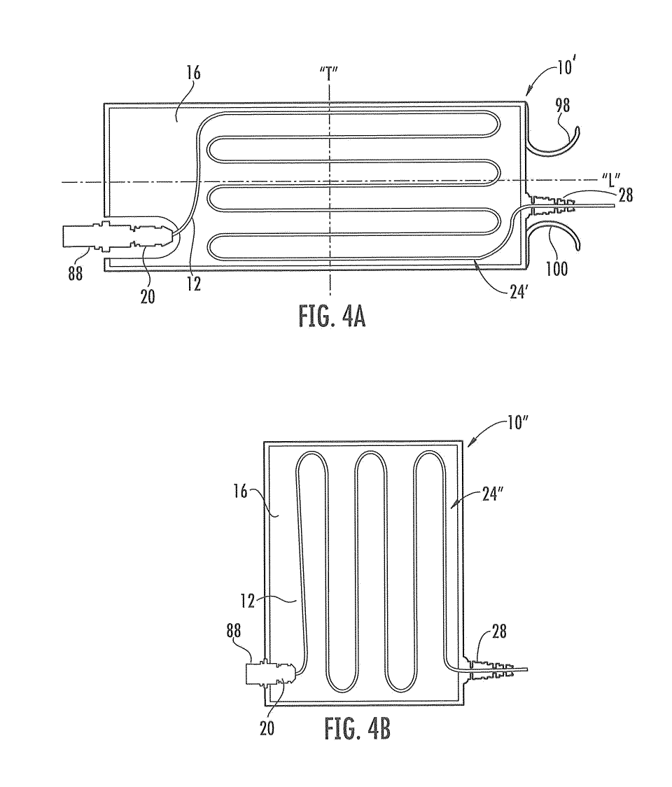

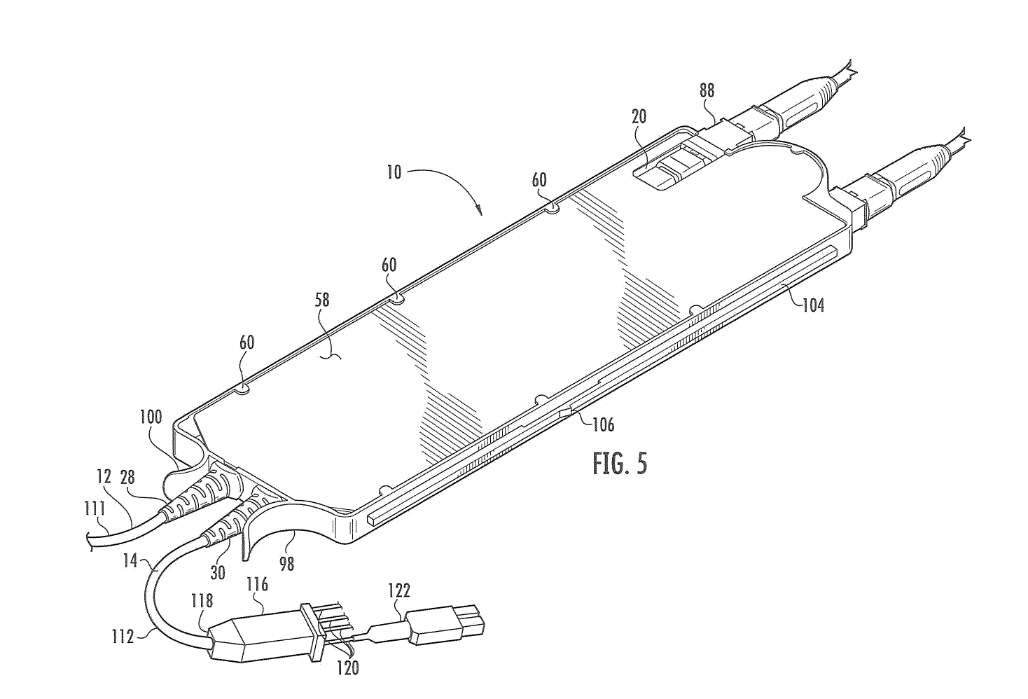

Referring now to FIGS. 4A and 4B, other exemplary embodiments of a fiber optic cable 24 in a fiber optic slack storage module 10′ and 10″, respectively, are shown. Components shown in FIGS. 4A and 4B that were shown and discussed with reference to FIGS. 1, 2 and 3 will not be discussed again. FIG. 4A illustrates a plan view of the fiber optic slack storage module 10′ adapted to receive and support the fiber optic cable 24 in a serpentine configuration 24′. In FIG. 4A, the serpentine configuration 24′ is arranged in a horizontal plane along the length or in line with the longitudinal axis “L” of the fiber optic cable slack storage module as the fiber optic cable extends along the length or in line with the longitudinal axis, of the fiber optic cable slack storage module. Although only one fiber optic cable 12 is shown in FIG. 4A, the fiber optic slack storage module 10′ may be adapted to receive and support the more than one fiber optic cable 24. FIG. 4B illustrates an elevation view of the fiber optic slack storage module 10″ adapted to receive and support the fiber optic cable 24 in a serpentine configuration 24″. In FIG. 4B the serpentine configuration 24″ is in a generally vertical plane. Alternatively, the serpentine configuration 24″ may be oriented at any angle to a horizontal plane. The fiber optic slack storage module 10″ may be suitable to be installed for example in a 4U enclosure, housing, or space in an equipment rack. Cable guides and/or fixtures may be used to place the fiber optic cable 12 in fiber optic slack storage module 10′ and 10″.

FIG. 5 illustrates a fully assembled slack storage module 10 with a portion of an upper cable harness 111 comprising the upper fiber optic cable 12 and a lower cable harness 112 comprising the lower fiber optic cable 14 installed therein. The following discussion will refer to the lower cable harness 112, but it should be understood that the same description may but does not have to apply to the upper cable harness 111, also. The lower cable harness 112 comprises the lower fiber optic cable 14, the lower connector 22 attached to a first end 115 of the lower fiber cable 14. Both the lower connector 22 and the first end 115 are hidden in FIG. 5. The lower cable harness 112 also comprises the boot 30, a furcation plug 116 attached to a second end 118 of the lower fiber cable 14, and multiple connectorized furcated fiber optic cables 120 outputted from the furcation plug 116. Fiber optic cables 120 furcated from the furcation plug 116 may be connectorized with a connector 122. Although in FIG. 5, only one fiber optic cable 120 is shown connectorized, all or any of the fiber optic cables 120 may be connectorized. Additionally, in FIG. 5 the connector 122 is a duplex LC fiber optic connector. However, any fiber optic connection type desired can be used for connector 122. The fully assembled fiber optic cable slack storage module 10 may be installed on a fiber optic equipment tray.

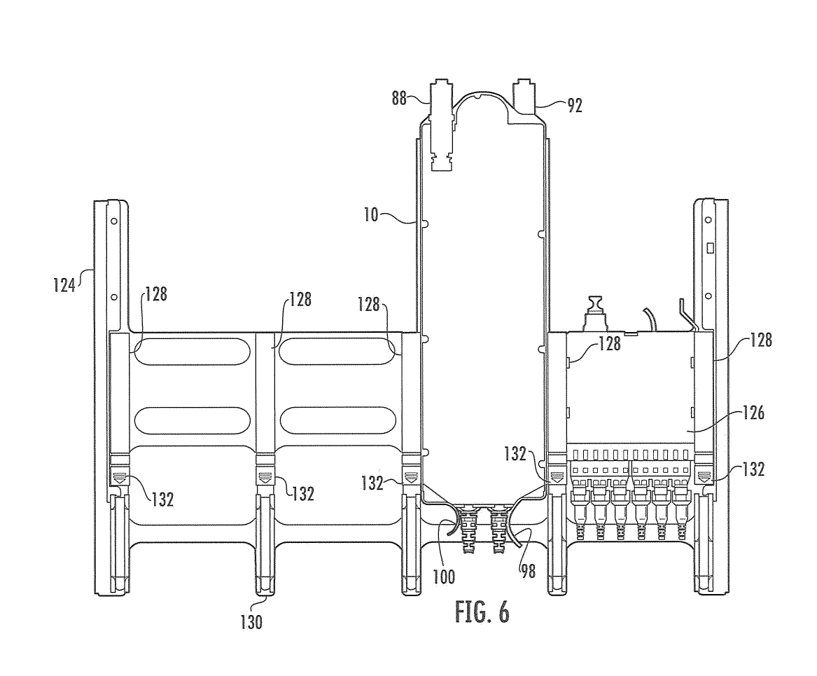

As mentioned above, the slack storage module 10 may be installed in a fiber optic tray without adjusting or modifying the fiber optic cable tray specifically for the slack storage module 10. FIG. 6 illustrates an embodiment of this. In FIG. 6 a slack storage module 10 according to an embodiment is shown installed in a fiber optic equipment tray 124. A connection module 126 with a different shape than the slack storage module 10 is also shown installed in the fiber optic equipment tray 124. As can be seen in FIG. 6, no modification needs to be made to the fiber optic equipment tray 124 so that it can receive and support both the connection module 126 and the slack storage module 10.

The first side rail 102 and the second side rail 104 are configured to be inserted within grooves (not shown) in the sides of the module rail guides 128 in the fiber optic equipment tray 124. In this manner, when it is desired to install the slack storage module 10 in the fiber optic equipment tray 124, the first end 18 of the slack storage module 10 can be inserted from the front end 130 of the fiber optic equipment tray 124. The slack storage module 10 can then be pushed towards the rear of the fiber optic equipment tray 124 so that the first side rail 102 and the second side rail 104 slide within the grooves in the module rail guides 128 until the latch 106 on the second side rail 104 reaches and inserts into a detent (not shown) in the module rail guide 128 to the right of the slack storage module 10. To remove the slack storage module 10 from the fiber optic equipment tray 124, release tab 132 to the right of the slack storage module 10 is depressed and the slack storage module 10 is pulled toward the forward direction using thumb pull 98 and finger pull 100. The slack storage module 10 moves out of the fiber optic equipment tray 124 by the first side rail 102 and the second side rail 104 sliding in the grooves in the module rail guides 128.

The slack storage module 10 is installed in and removably attached to the fiber optic equipment tray 124. Additionally, one or more fiber optic cables in the form of trunk cables may be interconnected with the upper fiber optic cable 12 and/or the lower fiber optic cable 14 through the upper adapter 88 and lower adapter 92, respectively. The upper fiber optic cable 12 and/or the lower fiber optic cable 14 may extend from and retract into the slack storage module 10 as discussed above with respect to FIG. 1. In this regard, a technician can make and/or change, as necessary, interconnections in the data center or central office and control the amount of slack in the fiber optic cable that may result from any such activity.

Many modifications and other embodiments will come to mind to one skilled in the art having the benefit of the teachings presented in the foregoing descriptions and the associated drawings. Therefore, it is to be understood that the description is not to be limited to the specific embodiments disclosed and that modifications and other embodiments are intended to be included within the scope of the appended claims. It is intended that the description cover the modifications and variations provided they come within the scope of the appended claims and their equivalents. Although specific terms are employed herein, they are used in a generic and descriptive sense only and not for purposes of limitation.

What is claimed is:

1. A fiber optic cable slack storage module, comprising:
a structure; and
an interior space defined by the structure, wherein the interior space is adapted to receive and support a first fiber optic cable arranged in a serpentine configuration, and wherein the interior space is adapted to allow movement of the fiber optic cable into and out of the slack storage module, and wherein a portion of the first fiber optic cable extends externally of the fiber optic slack storage module.

2. The fiber optic cable slack storage module of claim 1, wherein the serpentine configuration comprises a plurality of loops of the first fiber optic cable, and wherein the plurality of loops are in a back and forth arrangement in the slack storage module.

3. The fiber optic cable slack storage module of claim 1, wherein the serpentine configuration comprises a plurality of loops of the first fiber optic cable, and wherein the plurality of loops are in a side-to-side arrangement in the slack storage module.

4. The fiber optic cable slack storage module of claim 1, wherein the serpentine configuration comprises a plurality of loops of the first fiber optic cable, and wherein loops of the plurality of loops are non-overlapping.

5. The fiber optic cable slack storage module of claim 1, wherein the serpentine configuration comprises a plurality of loops of the first fiber optic cable, and wherein at least two loops of the plurality of loops overlap.

6. The fiber optic cable slack storage module of claim 1, wherein the serpentine configuration comprises a plurality of loops of the first fiber optic cable, and wherein the plurality of loops are in a back-and forth arrangement across the width of the fiber optic cable slack storage module.

7. The fiber optic cable slack storage module of claim 1, wherein the serpentine configuration comprises a plurality of loops of the first fiber optic cable, and wherein the plurality of loops are in a back-and forth arrangement across the length of the fiber optic cable slack storage module.

8. The fiber optic cable slack storage module of claim 1, wherein the serpentine configuration is arranged generally horizontally in the slack storage module.

9. The fiber optic cable slack storage module of claim 1, wherein the serpentine configuration is arranged generally vertically in the slack storage module.

10. The fiber optic cable slack storage module of claim 1, wherein the interior space is adapted to store at least about 54 inches of the first fiber optic cable.

11. The fiber optic cable slack storage module of claim 1, wherein the interior space is adapted to store from about 50 inches to about 60 inches of the first fiber optic cable.

12. The fiber optic cable slack storage module of claim 1, wherein the interior space is adapted to store from about 40 inches to about 70 inches of the first fiber optic cable.

13. The fiber optic cable slack storage module of claim 1, wherein a pulling force applied to the portion of the first fiber optic cable extending externally to the fiber optic slack storage module causes the serpentine configuration to begin to straighten and a portion of the first fiber optic cable to exit the slack storage module.

14. The fiber optic cable slack storage module of claim 1, wherein a pushing force applied to the portion of the first fiber optic cable extending externally to the fiber optic slack storage module causes a portion of the first fiber optic cable to enter the slack storage module and to arrange in the slack storage module in the serpentine configuration.

15. The fiber optic cable slack storage module of claim 1, wherein the interior space is adapted to receive and support a second fiber optic cable arranged in a serpentine configuration, and wherein the interior space is adapted to allow movement of the fiber optic cable into and out of the slack storage module, and wherein a portion of the second fiber optic cable extends externally of the fiber optic slack storage module.

16. The fiber optic slack storage module of claim 1, wherein the fiber optic slack storage module removably installs in a fiber optic equipment tray without the need for any modification or adaptation of the fiber optic equipment tray.

17. A fiber optic cable slack storage module, comprising:
a base comprising a first end, a second end, a first side and a second side defining an interior space, and wherein the base has a base top and a base bottom;
a plate mounted in the interior space having a plate top and a plate bottom, wherein the plate top orients substantially in the direction of the base top and plate bottom orients substantially in the direction of the base bottom, and wherein the plate is adapted to receive and support an upper fiber optic cable at the plate top in a first serpentine configuration and a lower fiber optic cable at the plate bottom in a second serpentine configuration;
wherein a portion of the upper fiber optic cable extends externally of the fiber optic slack storage module, and wherein a portion of the lower fiber optic cable extends externally of the fiber optic cable slack storage module.

18. The fiber optic cable storage module of claim 17, wherein the first serpentine configuration is the same as the second serpentine configuration.

19. The fiber optic cable storage module of claim 17, wherein one of the first serpentine configuration and the second serpentine configuration comprises a plurality of loops of the first fiber optic cable, and wherein the plurality of loops are in a back and forth arrangement.

20. The fiber optic cable slack storage module of claim 17, further comprising:
an upper adapter slot located in the first end, wherein the upper adapter slot is configured to receive an upper adapter for receiving an upper connector attached to a first end of the upper fiber optic cable; and
an upper connector cut-out in the plate and extending from the upper adapter slot, and wherein the upper connector cut-out provides access to the upper adapter, the upper connector and the upper fiber optic cable at the upper connector.

21. The fiber optic cable slack storage module of claim 17, further comprising a first boot slot in the second end, wherein the first boot slot is configured to receive a first boot, and wherein the upper fiber optic cable exits and enters the cable slack storage module through the first boot.

22. The fiber optic cable slack storage module of claim 21, wherein a pulling force applied to the portion of the upper fiber optic cable extending externally to the fiber optic slack storage module causes the first serpentine configuration of the upper fiber optic cable to begin to straighten and a portion of the upper fiber optic cable to exit the slack storage module through the first boot.

23. The fiber optic cable slack storage module of claim 21, wherein a pushing force applied to the portion of the upper fiber optic cable extending externally to the fiber optic slack storage module causes a portion of the upper fiber optic cable to enter the slack storage module through the first boot and to arrange in the slack storage module in the first serpentine configuration.

24. The fiber optic cable slack storage module of claim 17, further comprising:
a lower adapter slot located in the first end, wherein the lower adapter slot is configured to receive a lower adapter for receiving a lower connector attached to a first end of the lower fiber optic cable,; and
a lower connector cut-out in the plate and extending from the lower adapter slot, and wherein the lower connector cut-out provides access to the lower adapter, the lower connector and the lower fiber optic cable at the lower connector.

25. The fiber optic cable slack storage module of claim 17, further comprising a second boot slot in the second end, wherein the second boot slot is configured to receive a second boot, and wherein the lower fiber optic cable exits and enters the cable slack storage module through the second boot.

26. The fiber optic cable slack storage module of claim 25, wherein a pulling force applied to the portion of the lower fiber optic cable extending externally to the fiber optic slack storage module causes the second serpentine configuration of the lower fiber optic cable to begin to straighten and a portion of the lower fiber optic cable to exit the slack storage module through the second boot.

27. The fiber optic cable slack storage module of claim 25, wherein a pushing force applied to the portion of the lower fiber optic cable extending externally to the fiber optic slack storage module causes a portion of the lower fiber optic cable to enter the slack storage module through the second boot and to arrange in the slack storage module in a serpentine configuration.

28. The fiber optic cable slack storage module of claim 17, wherein the first end has an extended portion formed therein, and wherein the extended portion extends the length of the fiber optic cable slack storage module, and wherein the extended portion is used in loading the upper fiber optic cable and/or the lower fiber optic cable in the fiber optic cable slack storage module.

29. The fiber optic cable slack storage module of claim 17, further comprising
an upper cover removably attached to the base top.

30. The fiber optic cable slack storage module of claim 29, further comprising at least one upper tab attached to the base top, wherein the upper cover removably attaches to the base top by sliding between the at least one upper tab and the base top.

31. The fiber optic cable slack storage module of claim 17, further comprising
a lower cover removably attached to the base bottom.

32. The fiber optic cable slack storage module of claim 31, further comprising
at least one lower tab attached to the base bottom, wherein the lower cover removably attaches to the base bottom by sliding between the at least one lower tab and the base bottom.

33. The fiber optic cable slack storage module of claim 17, further comprising:
a first side rail attached to the first side;
a second side rail attached to the second side; and
a latch positioned in the second side rail, wherein the first side rail and the second side rail insert into grooves in module rail guides in a fiber optic equipment tray to removably attach the fiber optic cable slack storage module in the fiber optic equipment tray, and wherein the latch inserts into a detent in one of the module rail guides to releasably lock the fiber optic cable slack storage module in the fiber optic equipment tray.

34. The fiber optic slack storage module of claim 17, further comprising:
a thumb pull and a finger pull, wherein the thumb pull and the finger pull attach to the second end, and wherein the thumb pull and the finger pull are used to remove the fiber optic cable slack storage module from a fiber optic equipment tray.
